(19) United States
(12) Patent Application Publication
(10) Pub. No.: US 2012/0186750 A1
(43) Pub. Date: Jul. 26, 2012

(54) TAPE AFFIXING APPARATUS FOR BAND-SHAPED ACCESSORY

(75) Inventor: Kei Kamiyama, Tokyo (JP)

(73) Assignee: EPOCH COMPANY LTD., Tokyo (JP)

(21) Appl. No.: 13/353,547

(22) Filed: Jan. 19, 2012

(30) Foreign Application Priority Data
Jan. 21, 2011 (JP) 2011-011105

(51) Int. Cl. B32B 37/10

(52) U.S. Cl. 156/446

(57) ABSTRACT

A tape affixing apparatus for a band-shaped accessory can easily affix a decorative tape to a band-shaped accessory such as a katyusha, a bracelet or a necklace so as to change patterns on the band-shaped accessory variously. The tape affixing apparatus affixes the decorative tape to a band-shaped accessory curved substantially into an arc-like shape and having flexibility. A main body has an insertion port from which the band-shaped accessory can be inserted, a rotational portion which moves the band-shaped accessory inserted in a predetermined direction, and a presser roller which presses vertically the band-shaped accessory inserted together with the rotational portion. The decorative tape is affixed to a surface of the band-shaped accessory by inserting the band-shaped accessory into the insertion port in the main body and rotating the rotational portion.

### CROSS-REFERENCE TO RELATED APPLICATION

This patent application is based upon and claims the benefit of priority under 35 USC 119 of Japanese Patent Application No. 2011-011105 filed on Jan. 21, 2011, the entire contents of which are incorporated herein by reference.

### BACKGROUND OF THE INVENTION

1. Field of the Invention

The present invention relates to a tape affixing apparatus for affixing easily various decorative tapes to a band-shaped accessory such as a headband or katyusha, a bracelet or a necklace.

2. Description of the Related Art

Conventionally, a katyusha is a band-shaped hair ornament having a C-shape which is designed to be worn around the head. When worn, the katyusha also serves to secure or tie back the hair. In particular, the katyusha is widely popular among children as a kind of dress-up toy to adorn the hair. Further, the katyusha also functions as one of accessories which can be used in a variety of ways: the katyusha can be worn for a romantic appointment, a party, or a special situation such as a wedding ceremony. The katyusha can also be worn in everyday life.

However, in general, the katyusha is not such a hair ornament that the user can change its design freely after she has bought it. Because of this, when dressing themselves up, consumers have to purchase several kinds of katyushas which differ in design to match clothing or other accessories worn, leading to a problem that buying several kinds of katyushas is not economical.

To cope with this problem, Japanese Utility Model Registration No. 3070220, which is referred to as Patent Literature 1, discloses a set of katyushas of different colors and patterns which can be combined in multiple to form a single katyusha. According to the katyushas described in Patent Literature 1, the user can enjoy wearing katyushas of different designs which result by combining some of the katyushas in several ways.

### BRIEF SUMMARY OF THE INVENTION

However, in the katyushas described in Patent Literature 1, each katyusha has irregularities along both side edges thereof, and some of the katyushas of different colors and patterns are combined together by irregularities thereof being fitted together to form a katyusha of a specific combination of colors and patterns. Therefore, many katyushas are necessary to be prepared for a wide range of designs.

Thus, the invention has been made in view of the problem inherent in the conventional katyushas, and an object thereof is to provide a tape affixing apparatus for a band-shaped accessory which can affix easily a decorative tape to a band-shaped accessory such as a headband or katyusha, a bracelet or a necklace so as to change patterns on the band-shaped accessory in various ways.

According to a first aspect of the invention, there is provided a tape affixing apparatus for a band-shaped accessory for affixing a decorative tape to a band-shaped accessory which is curved substantially into an arc-like shape and which has flexibility, wherein a main body has an insertion port from which the band-shaped accessory can be inserted, a rotational portion which moves the band-shaped accessory inserted in a predetermined direction, and a presser roller which presses the band-shaped accessory inserted vertically together with the rotational portion, and wherein the decorative tape is affixed to a surface of the band-shaped accessory by inserting the band-shaped accessory into the insertion port in the main body and rotating the rotational portion.

According to a second aspect of the invention, there is provided a tape affixing apparatus for a band-shaped accessory as set forth in the first aspect of the invention, comprising a tape holding device which is adapted to accommodate the decorative tape therein and which can be incorporated in the main body of the tape affixing apparatus for a band-shaped accessory, wherein the tape holding device which accommodates the decorative tape is connected to the main body.

According to a third aspect of the invention, there is provided a tape affixing apparatus for a band-shaped accessory as set forth in the first aspect of the invention, wherein the decorative tape is a decorative tape for a band-shaped accessory which is made up of the decorative tape and a strippable paper carrier.

According to a fourth aspect of the invention, there is provided a tape affixing apparatus for a band-shaped accessory as set forth in the second aspect of the invention, wherein the decorative tape is a decorative tape which is made up of the decorative tape and a strippable paper carrier, and wherein the tape holding device has a guide plate which guides the decorative tape of the decorative tape, a separation guide which separates the decorative tape from the strippable paper carrier of the decorative tape, and a discharge port from which the strippable paper carrier of the decorative tape which is separated from the decorative tape is discharged.

According to a fifth aspect of the invention, there is provided a tape affixing apparatus for a band-shaped accessory as set forth in the fourth aspect of the invention, wherein the tape holding device comprises a winding shaft which winds up the decorative tape to lock it therearound.

According to a sixth aspect of the invention, there is provided a tape affixing apparatus for a band-shaped accessory as set forth in the fourth aspect of the invention, wherein the tape holding device comprises projecting portions where the decorative tape and the strippable paper carrier of the decorative tape which is wound around the winding shaft to be locked therearound are temporarily fastened when the decorative tape and the strippable paper carrier are separated from each other.

According to a seventh aspect of the invention, there is provided a tape affixing apparatus for a band-shaped accessory as set forth in the first aspect of the invention, wherein the main body comprises an elastic element which supports the presser roller.

According to an eighth aspect of the invention, there is provided a tape affixing apparatus for a band-shaped accessory as set forth in the first aspect of the invention, wherein the rotational portion comprises a pressing portion having elasticity.

According to a ninth aspect of the invention, there is provided a tape affixing apparatus for a band-shaped accessory as set forth in the first aspect of the invention, wherein the band-shaped accessory is a katyusha.

According to a tenth aspect of the invention, there is provided a tape affixing apparatus for a band-shaped accessory as set forth in the first aspect of the invention, wherein the rotational portion is rotated manually or electrically using an electric motor.

According to the invention, the tape affixing apparatus for a band-shaped accessory can be provided in which the decorative tape can easily be affixed to the band-shaped accessory such as a headband or katyusha, a bracelet or a necklace, thereby making it possible to change patterns variously on the band-shaped accessory.

According to the invention, the tape holding device is provided which is adapted to accommodate the decorative tape and which can be incorporated in the main body, whereby the decorative tape can easily be set for fixation to the band-shaped accessory.

According to the invention, the decorative tape is the decorative tape for the band-shaped accessory which is made up of the decorative tape and the strippable paper carrier, whereby the decorative tape can be stored without getting dirty or adhering to others.

According to the invention, the tape holding device has the guide plate which guides the decorative tape of the decorative tape, the separation guide which separates the decorative tape from the strippable paper carrier of the decorative tape, and the discharge port from which the strippable paper carrier of the decorative tape which is separated from the decorative tape is discharged, whereby the decorative tape can be affixed accurately to the band-shaped accessory.

According to the invention, the tape holding device comprises the winding shaft, whereby various types of decorative tapes can be wound around the winding shaft for accommodation in the tap holding device.

According to the invention, the tape holding device comprises the projecting portions where the decorative tape and the strippable paper carrier of the decorative tape are temporarily fastened when the decorative tape and the strippable paper carrier are separated from each other, whereby when the decorative tape is accommodated in the tape holding device, the decorative tape and the strippable paper carrier which have been separated from each other can be prevented from adhering to each other.

According to the invention, the main body comprises the elastic element which supports the presser roller, whereby the space between the rotational portion and the presser roller can be changed flexibly to cope with band-shaped accessories having different thicknesses.

According to the invention, the rotational portion comprises the pressing portion, whereby the band-shaped accessory which is inserted into the space defined between the rotational portion and the presser roller can be moved with no slippage in an ensured fashion by rotating the rotational portion.

According to the invention, by adopting the katyusha as the band-shaped accessory, the katyusha can be produced which can change patterns variously thereon, thereby making it possible to expand the possibility that the user can dress herself up variously.

According to the invention, the rotational portion can be rotated manually or electrically using the electric motor, thereby making it possible to affix easily the decorative tape to the band-shaped accessory.

### BRIEF DESCRIPTION OF THE SEVERAL VIEWS OF THE DRAWINGS

FIG. 1 is a perspective view of a tape affixing apparatus for a band-shaped accessory according to an embodiment of the invention.

FIG. 2 is a perspective view of the tape affixing apparatus for a band-shaped accessory according to the embodiment of the invention with a tape holding device removed therefrom.

FIG. 3 is a front sectional view of the tape affixing apparatus for a band-shaped accessory according to the embodiment of the invention.

FIG. 4 is an exploded perspective view of the tape holding device of the tape affixing apparatus for a band-shaped accessory according to the embodiment of the invention.

FIG. 5 (a), (b), (c) and (d) show explanatory diagrams which show steps of winding a decorative tape around the tape holding device according to the embodiment of the invention.

FIG. 6 is an exploded perspective view of a main body of the tape affixing apparatus for a band-shaped accessory according to the embodiment of the invention.

FIG. 7 (a) and (b) show explanatory diagrams which show how to use the tape affixing apparatus for a band-shaped accessory according to the embodiment of the invention.

### DETAILED DESCRIPTION OF THE REFERRED EMBODIMENT

An embodiment of the invention will be described. A tape affixing apparatus for a band-shaped accessory 10 includes a tape holding device 20 which accommodates a decorative tape 21 in a wound-up state. This decorative tape 21 is made up of a decorative tape 22 having an adhesive layer on a back side thereof and a strippable paper carrier 23. In addition, the tape affixing apparatus for a band-shaped accessory 10 includes a main body 50 which can incorporate therein the tape holding device 20. The tape holding device 20 includes a guide plate 32 for guiding the decorative tape 22 of the decorative tape 21, a separation guide 34 for separating the decorative tape 22 and the strippable paper carrier 23 of the decorative tape 21 from each other, and a discharge port 33 from which the strippable paper carrier 23 of the decorative tape 21 is discharged after the strippable paper carrier 23 is separated from the decorative tape 22. The main body 50 has an insertion port 11 into which a band-shaped accessory such as a headband or katyusha 100 which is a tape affixation object is inserted, a rotational portion 51 which moves the band-shaped accessory such as the katyusha 100 inserted in a predetermined direction, and a presser roller 52 which presses the band-shaped accessory such as the katyusha 100 inserted vertically together with the rotational portion 51. In the tape affixing apparatus for a band-shaped accessory 10, the tape holding device 20 which accommodates the decorative tape 21 is connected to the main body 50, and after the band-shaped accessory is inserted into the insertion port 11 in the main body 50, the rotational portion is rotated, whereby the decorative tape 22 can be affixed to a surface of the band-shaped accessory.

In addition, the tape holding device 20 includes a winding shaft around which the decorative tape 21 is wound to be locked thereon. The tape holding device 20 also includes projecting portions 35, 36 on which the decorative tape 22 and the strippable paper carrier 23 of the decorative tape 21 are temporarily fastened, respectively, when they are separated from each other. Additionally, the rotational portion 51 is rotated manually or electrically using an electric motor.

The main body 50 includes an elastic element 53 which supports a presser roller 52. In addition, the rotational portion 51 includes elastic pressing portions 62 64.

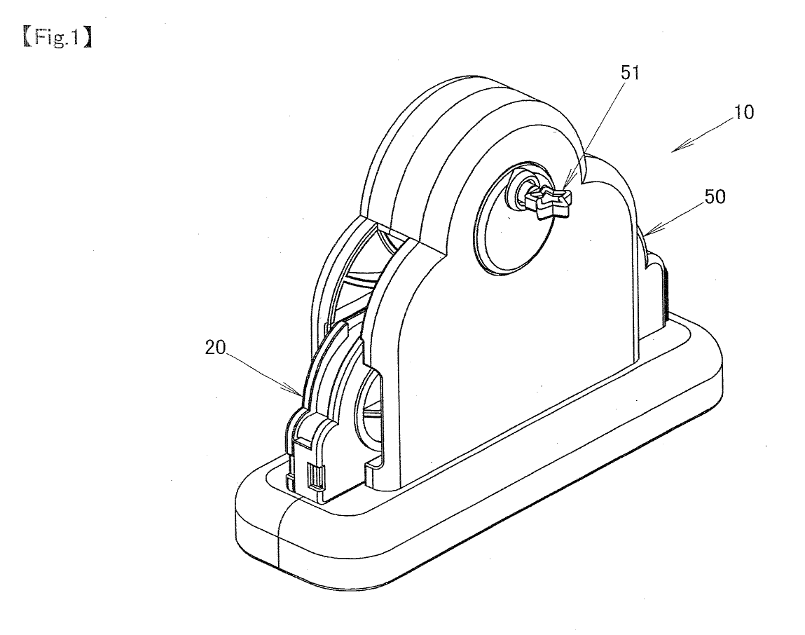

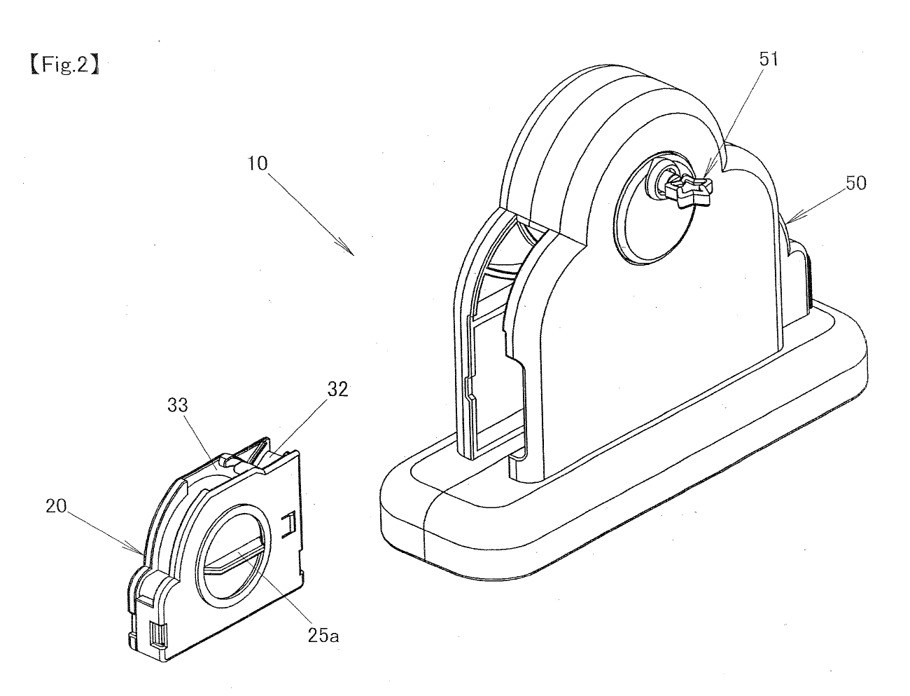

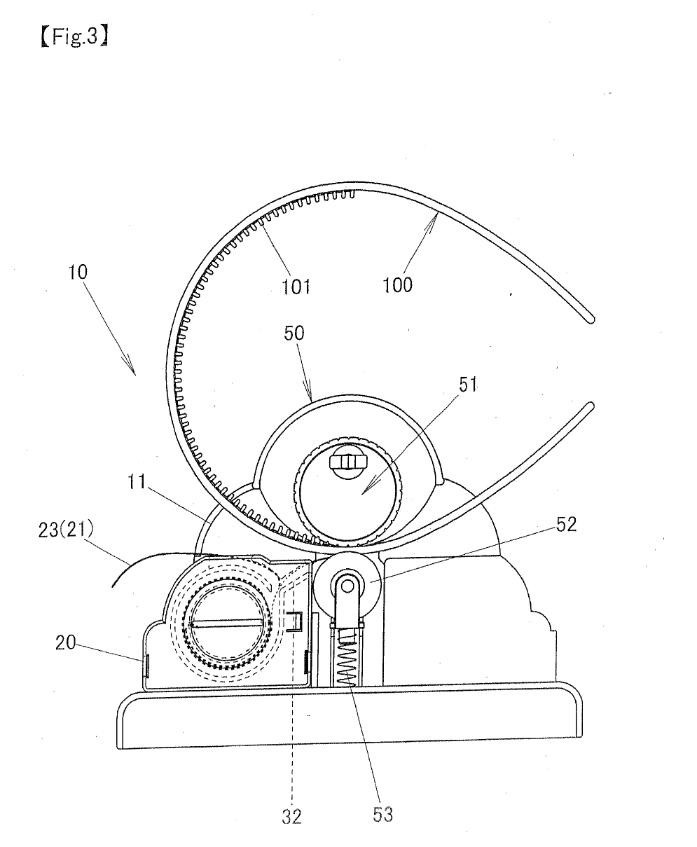

Hereinafter, an embodiment of the invention will be described in detail by reference to the drawings. FIG. 1 is a perspective view of a tape affixing apparatus for a band-shaped accessory 10. FIG. 2 is a perspective view of the tape affixing apparatus for a band-shaped accessory 10 with a tape holding device 20 removed therefrom. FIG. 3 is a front sectional view of the tape affixing apparatus for a band-shaped accessory 10.

As to the tape affixing apparatus for a band-shaped accessory 10 shown in FIG. 1, a side of the tape affixing apparatus for a band-shaped accessory 10 is referred to as front where a lug of a rotational portion 51 which is located in an upper central position exists, while an opposite side is referred to as rear. In addition, a left-hand side of the tape affixing apparatus for a band-shaped accessory 10 shown in FIG. 1 from which a tape holding device 20 is incorporated thereinto is referred to as an entrance side, while a right-hand side of the tape affixing apparatus for a band-shaped accessory 10 is referred to as an exit side.

This tape affixing apparatus for a band-shaped accessory is designed to affix a decorative tape to a band-shaped accessory such as a headband or katyusha, a band-shaped necklace or a bracelet which constitutes a tape affixation object. The width and length of a decorative tape that can be used in the tape affixing apparatus for a band-shaped accessory 10 vary with the width and length of a tape affixation object: the width ranges approximately from 7 to 13 mm and the length ranges approximately from 10 to 13 cm.

As shown in FIG. 1, the tape affixing apparatus for a band-shaped accessory 10 includes the tape holding device 20 and a main body 50. The main body 50 includes the rotational portion 51 at an upper central portion thereof.

In the tape affixing apparatus for a band-shaped accessory 10, as shown in FIG. 2, the tape holding device 20 can be removed from the main body 50 by being pulled out of the entrance side of the main body 50. Hereinafter, a case will be described in which a decorative tape is affixed to a headband or katyusha 100 which functions as a band-shaped accessory.

The tape affixing apparatus for a band-shaped accessory 10 is designed so that the tape holding device 20 which accommodates therein a decorative tape 21 is connected to the main body 50 as shown in FIG. 3 and after the katyusha 100 is inserted into an insertion port 11 in the main body 50, the rotational portion 51 is rotated, whereby a decorative tape of the decorative tape 21 is affixed to a surface of the katyusha 100 in such a manner as to be wound therearound while forcibly holding the katyusha by the rotational portion 51 and a presser roller 52 therebetween. The configuration of the main body 50 will be described in detail later by reference to an exploded view thereof.

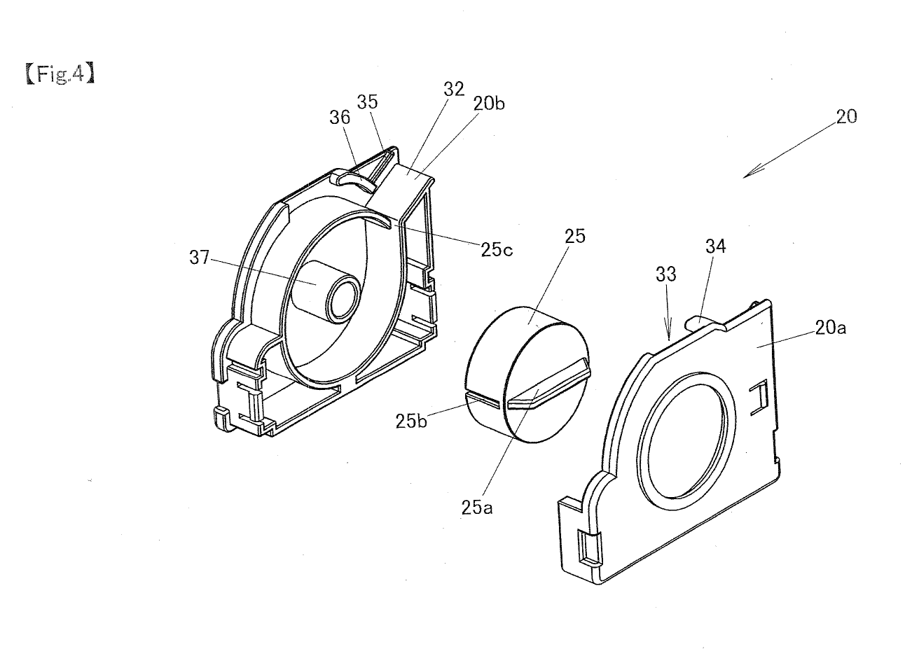

Firstly, the tape holding device 20 will be described in detail by reference to the drawing. FIG. 4 is an exploded perspective view of the tape holding device 20.

Respective portions of the tape holding device 20 are formed of a hard resin. As shown in FIG. 4, the tape holding device 20 has a front plate 20a and a back member 20b and includes a winding shaft 25 which is detachably mounted at an interior central portion of the back member 20b.

The front plate 20a has a flat plate-like shape and includes a locking portion which is provided at a portion along a circumferential edge thereof so as to project to the rear so as to be fitted together with the back member 20b. A circular window is formed in a central portion of a front side of the front plate 20a so that a front portion of the winding shaft 25 can be exposed therefrom. A separation guide 34 is formed on the front plate 20a so as to separate the decorative tape and a strippable paper carrier 23 of the decorative tape 21 from each other.

The back member 20b constitutes an accommodation member which accommodates therein the winding shaft 25 and includes a locking portion which is provided at a portion along a circumferential edge thereof so as to be fitted together with the front plate 20a. The back member 20b has a bearing 37 which is formed at a central portion on a front side of the back member 20b so as to fit on a shaft provided on a back side of the winding shaft 25. Additionally, the back member 20b includes a tape insertion port 25c from which the decorative tape 21 is wound around the winding shaft 25 and a guide plate 32 which guides the decorative tape of the decorative tape 21 which is wound around the winding shaft 25.

A first projecting portion 35 is formed on the back member 20b. The first projecting portion 35 is a projecting portion to which the decorative tape of the decorative tape 21 which is wound around the winding shaft 25 so as to be locked thereon is temporarily fastened when the decorative tape is separated from the strippable paper carrier 23. Further, a second projecting portion 36 is formed on the back member 20b. The second projecting portion 36 is a projecting portion to which the strippable paper carrier 23 of the decorative tape 21 is temporarily fastened after the strippable paper carrier 23 is separated from the decorative tape.

The winding shaft 25 includes a lug portion 25a provided on a front side thereof by which the decorative tape 21 is wound around the winding shaft 25 and a locking portion 25b in which a leading end of the decorative tape 21 is locked when the decorative tape 21 is wound around the winding shaft 25.

A discharge port 33 is formed in an upper portion of the tape holding device 20 which is formed by combining the back member 20b and the front plate 20a together in a position lying to a left-hand side of the separation guide 34. The strippable paper carrier 23 of the decorative tape 21 is discharged from this discharge port 33 after it has been separated from the decorative tape (refer to FIG. 2).

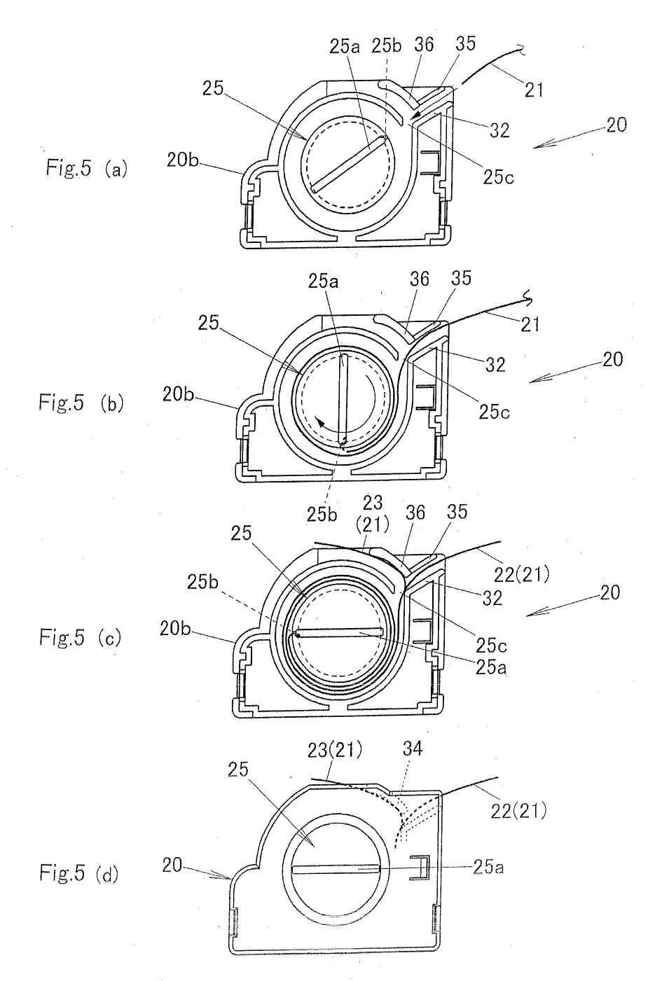

Here, how to mount the decorative tape 21 in the tape holding device will be described by reference to the drawing. FIG. 5 (a), (b), (c) and (d) show explanatory drawings which illustrate steps of winding the decorative tape 21 around the winding shaft 25 of the tape holding device 20.

As shown in FIG. 5(a), the lug portion 25a is rotated so that the locking portion 25b of the winding shaft 25 which is accommodated in the back member 20b of the tape holding device 20 coincides with the tape insertion port 25c in the back member 20b. Then, a decorative tape 21 made up of a decorative tape 22 and a strippable paper carrier 23 and having a width matching a width of the katyusha 100 is prepared and is then cut to a length matching an overall length of the katyusha 100 in advance. Then, a leading end of the decorative tape 21 so cut is inserted from the tape insertion port 25c so that the decorative tape 22 is oriented downwards so as to be brought into engagement with the locking portion 25b in the winding shaft 25. Next, as shown in FIG. 5(b), the lug portion 25a is rotated clockwise to thereby wind the decorative tape 21 around the winding shaft 25.

Then, as shown in FIG. 5(c), the decorative tape 22 and the strippable paper carrier 23 at a trailing end of the decorative tape 21 which is wound around the winding shaft 25 are separated from each other. Part of a back side of the decorative tape 22 of the decorative tape 21 which is separated from the strippable paper carrier 23 is temporarily fastened to the first projecting portion 35 of the back member 20b, and the decorative tape 22 of the decorative tape 21 is disposed on the guide plate 32.

The strippable paper carrier 23 which is separated from the decorative tape 22 is temporarily fastened to the second projecting portion 36 of the back member 20b at part of a back side thereof. Then, as shown in FIG. 5(d), the strippable paper carrier 23 of the decorative tape 21 is disposed so as to be discharged outwards from the discharge port 33 which is formed when the front plate 20a is fitted together with the back member 20b, whereby the tape holding device 20 is put in a state in which the decorative tape 21 is accommodated therein.

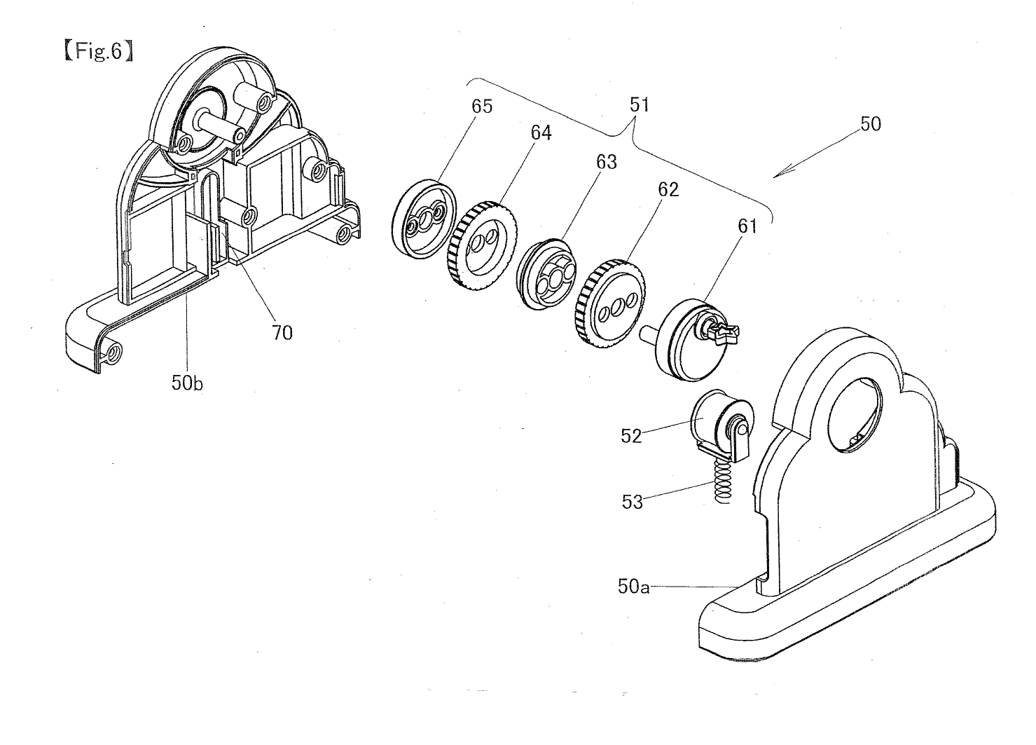

Next, a mechanism of affixing the decorative tape 22 to the surface of the katyusha 100 will be described by reference to the drawing. This mechanism is possessed by the main body 50. FIG. 6 is an exploded perspective view of the main body 50 of the tape affixing apparatus for a band-shaped accessory 10.

In the main body 50 of the tape affixing apparatus for a band-shaped accessory 10, the rotational portion 51, the presser roller 52 and the elastic element 53 are disposed in predetermined positions. A front cover 50a and a rear cover 50b are fitted together and are then joined together with screws, whereby the main body 50 is completed.

The front cover 50a is formed of a hard resin and includes the circular window which is formed in the upper central portion thereof so that the rotational portion 51 is exposed therefrom. The rear cover 50b is formed of a hard resin and includes the bearing which is formed at the upper central portion on an inner or front side thereof so that the rotational portion 51 can support rotatably the rotational portion 51.

An accommodation portion which accommodates the elastic element 53 so as to extend and contract elastically is formed in an interior space defined by inner sides of the front cover 50a and the rear cover 50b. Further, a groove 70 is also formed in the interior space defined the inner sides of the front cover 50a and the rear cover 50b, and this groove 70 functions as an accommodation portion which accommodates a support element which supports the presser roller 52 together with the elastic element 53.

The rotational portion 51 is made up of a front plate 61, a first pressing portion 62, an intermediate plate 63, a second pressing portion 64 and a rear plate 65.

The front plate 61 is formed of resin and is positioned to face the front cover 50a. The front plate 61 has a lug which facilitates the rotation of the rotational portion 51. The first pressing portion 63 and the second pressing portion 64 are formed of a resin having elasticity and are adapted to press an inner side of the katyusha 100 from thereabove.

The intermediate plate 63 is formed of resin and is interposed between the first pressing portion 62 and the second pressing portion 64. A diameter of the intermediate plate 63 is made smaller than those of the first pressing portion 62 and the second pressing portion 64 so as to form an annular space around a circumference of the intermediate plate 63 of the rotational portion 51 so that the intermediate plate 63 does not come into interference with projecting portions 101 on a back side, that is, the inner side of the katyusha 100, when the inner side of the katyusha 100 is pressed down from thereabove by the first pressing portion 62 and the second pressing portion 64.

The rear plate 65 is formed of resin and is positioned so as to face the rear cover 50b. The rear plate 65 is jointed together with the front plate 61 with screws, with the first pressing portion 62, the intermediate plate 63 and the second pressing portion 64 interposed therebetween.

The presser roller 52 is formed of a resin having elasticity and is supported rotatably by the support element. The presser roller 52 is adapted to press the surface or front side of the katyusha 100 to which the decorative tape 21 is affixed from therebelow.

The elastic element 53 is adapted not only to support the support element from therebelow which supports rotatably the presser roller 52 but also to bias the presser roller 52 upwards. In addition, the elastic element 53 is adapted to change a space defined between the rotational portion 51 and the presser roller 52 flexibly so as to properly deal with katyushas having various thicknesses.

In addition, by connecting the tape holding device 20 which accommodates therein the decorative tape 21 to the main body 50, the guide plate 32 of the tape holding device 20 on which the decorative tape 22 of the decorative tape 21 is disposed as shown in FIG. 3 is disposed so as to guide the leading end of the decorative tape 22 to a portion which is in abutment with the presser roller 52.

Additionally, by connecting the tape holding device 20 in which the decorative tape 21 is wound around the winding shaft 25 to the main body 50, the strippable paper carrier 23 of the decorative tape 21 which is discharged from the discharge port 33 in the tape holding device 20 is exposed to the outside of the tape affixing apparatus for a band-shaped accessory 10.

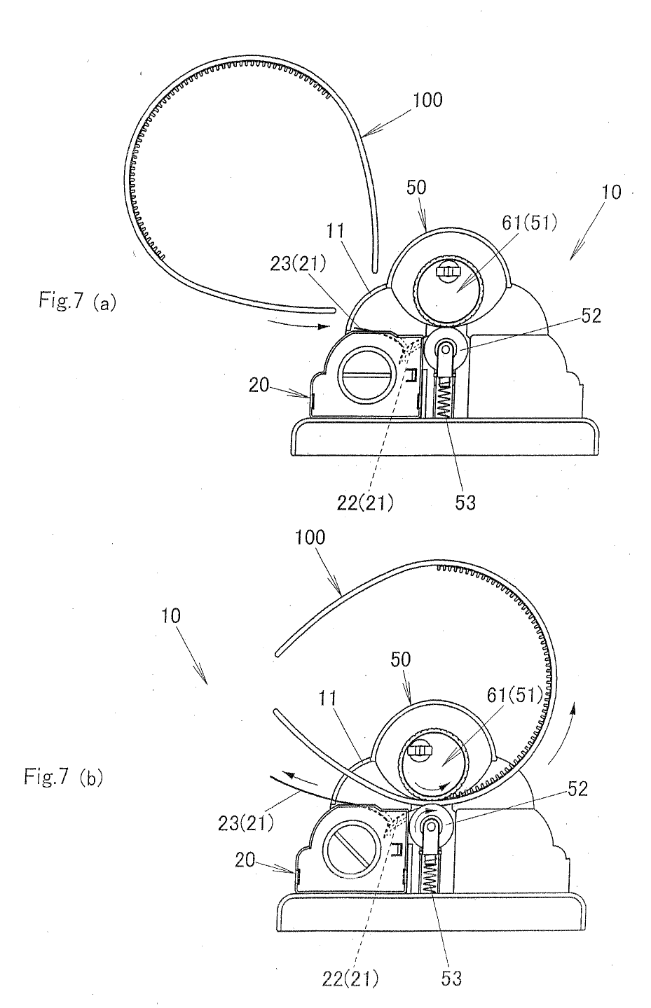

Then, as shown in FIG. 7(a), when a leading end of the katyusha 100 is inserted from the insertion port 11 which is positioned on the entrance side of the tape affixing apparatus for a band-shaped accessory 10 with the surface or front side of the katyusha 100 oriented downwards, firstly, the decorative tape 22 of the decorative tape 21 which is disposed on the portion of the tape holding device 20 where the guide plate 32 is disposed is brought into abutment with the leading end of the katyusha 100. Then, the decorative tape 22 of the decorative tape 21 is affixed to a front side of the leading end of the katyusha 100 and is then guided into the space defined between the rotational portion 51 and the presser roller 52 of the main body 50, where the decorative tape 22 is stopped. This completes the preparation for affixation of the decorative tape 22 to the surface of the katyusha 100.

Then, as shown in FIG. 7(b), when the front plate 61 of the rotational portion 51 is rotated manually counterclockwise, the katyusha 100 is pressed by the rotational portion 51 and the presser roller 52 therebetween, whereby the decorative tape 22 is affixed to the surface of the katyusha 100 so as to be wound therearound. Then, the katyusha 100 is moved to the exit side of the tape affixing apparatus for a band-shaped accessory 10 and is then discharged from the discharge port which is situated on the exit side of the tape affixing apparatus for a band-shaped accessory 10.

The method of rotating the rotational portion 51 is not limited to the method of rotating manually the front plate 61 of the rotational portion 51 counterclockwise. For example, a method may be adopted of rotating electrically the rotational portion 51 by employing an electric motor. Namely, the tape affixing apparatus for a band-shaped accessory 10 of this embodiment can be applied to a configuration in which a battery, a start switch and the electric motor are installed in the tape affixing apparatus, whereby a rotational member which is the rotational portion 51 is rotated electrically counterclockwise by the electric motor by depressing the start switch, so that the decorative tape 22 is affixed to the surface of the katyusha 100.

The invention is not limited to the embodiment that has been described heretofore, and therefore, there may be a case where a tape affixing apparatus for a band-shaped accessory is provided which has no tape holding device.

This tape affixing apparatus for a band-shaped accessory which has no tape holding device includes a main body in which a band-shaped accessory to which a decorative tape is affixed and a decorative tape which is made up of a decorative tape and a strippable paper carrier are disposed. Additionally, a rotational portion is provided at an upper central portion of the main body.

In the tape affixing apparatus for a band-shaped accessory which has no tape holding device, the decorative tape is inserted from a tape insertion port which is provided below an entrance side of the main body, and the decorative tape is separated into the decorative tape and the strippable paper carrier by a strippable paper carrier separating shaft which lies in the vicinity of the tape insertion port and which is erected in a front-to-rear direction of the tape affixing apparatus for a band-shaped accessory.

The decorative tape separated passes below the strippable paper carrier separating shaft and is inserted until it is brought into abutment with a lower roller within the main body by a guide which reaches the lower roller, where the decorative tape is stopped. Then, the strippable paper carrier separated passes above the strippable paper carrier separating shaft and is caused to make a U-turn to thereby be discharged from a tape insertion port side of the tape affixing apparatus for a band-shaped accessory.

By adopting this configuration, even in the event that the tape holding device which accommodates a decorative tape is not provided, the decorative tape of the decorative tape can be wound around the surface of the band-shaped accessory such as the katyusha while forcibly pressing the band-shaped accessory by the rotational portion and the presser roller therebetween by inserting the band-shaped accessory into the insertion port in the main body and rotating the rotational portion.

Further, a tape affixing apparatus for a band-shaped accessory of a different type can be provided. In this tape affixing apparatus for a band-shaped accessory, a decorative tape having no strippable paper carrier is used. A pattern is drawn and a strippable coating acting as a strippable layer is applied to a front side of the decorative tape. In addition, an adhesive layer is provided on a back side of the decorative tape. Then, this decorative tape is cut to a predetermined length and is then wound into a spiraling pattern for accommodation in a tape holding device.

In this configuration, the tape holding device which accommodates the decorative tape which is wound into the spiraling pattern is connected to the main body, a band-shaped accessory is inserted into the insertion port in the main body, and the rotational portion is rotated, whereby the decorative tape is continuously pulled out of the spirally wound state in the tape holding device so as to be affixed to the band-shaped accessory in such a manner as to be wound therearound while being forcibly pressed by the rotational portion and the presser roller therebetween.

By adopting this configuration, even in the case of the tape holding device being provided which accommodates the decorative tape which has the adhesive layer on the back side thereof in place of the strippable paper carrier and which is wound into the spiraling pattern, by inserting the band-shaped accessory such as the katyusha into the insertion port in the main body and rotating the rotational portion, the decorative tape can be wound around the surface of the band-shaped accessory while being forcibly pressed by the rotational portion and the presser roller therebetween.

In the embodiment of the invention, while the tape affixing apparatus for a band-shaped accessory 10 has been described as being applied to the tape affixing apparatus for affixing the decorative tape 22 to the katyusha 100, the invention is not limited thereto. For example, the invention can also be applied to a tape affixing apparatus for a band-shaped accessory for affixing the decorative tape 22 to a band-shaped accessory such as a bracelet or a necklace which is curved substantially into an arc-like shape and which has flexibility. Namely, in the case of band-shaped accessories having thicknesses and widths which fall in predetermined ranges, by using the tape affixing apparatus described above, the decorative tape 22 can be affixed to a surface of a band-shaped accessory in such a manner as to be wound therearound by inserting the band-shaped accessory into the insertion port 11 in the main body 50 and rotating the rotational portion 51.

Thus, according to the embodiment of the invention, the tape affixing apparatus for a band-shaped accessory 10 can be provided by which the decorative tape 22 can easily be affixed to the band-shaped accessory.

Further, according to the embodiment of the invention, by including the tape holding device 20 which accommodates the decorative tape 22 and which can be incorporated in the main body 50, the decorative tape 22 to be affixed can easily be set.

In addition, according to the embodiment of the invention, in the event that the decorative tape 22 is the decorative tape 21 which is made up of the decorative tape 22 and the strippable paper carrier 23, the decorative tape 22 can be stored without getting dirty or adhering to others.

Additionally, according to the embodiment of the invention, the tape holding device 20 has the guide plate 32 which guides the decorative tape 22 of the decorative tape 21, the separation guide 34 which separates the decorative tape 22 and the strippable paper carrier 23 of the decorative tape 21 from each other, and the discharge port 33 from which the strippable paper carrier 23 of the decorative tape 21 is discharged after the strippable tape carrier 23 is separated from the decorative tape 22. Therefore, the decorative tape 22 can be affixed accurately to the band-shaped accessory.

In addition, according to the embodiment of the invention, by including the winding shaft 25 which can detachably mounted in the tape holding device 20, various types of decorative tapes can easily be wound around the winding shaft 25 for accommodation in the tape holding device 20.

Further, according to the embodiment of the invention, the tape holding device 20 includes the projecting portions 35, 36 to which the decorative tape 22 and the strippable paper carrier of the decorative tape 21 are temporarily fastened, respectively, after the decorative tape 22 and the strippable paper carrier 23 are separated from each other. Therefore, when the decorative tape 21 is accommodated in the tape holding device 20, the adhesion of the decorative tape 22 and the strippable paper carrier 23 which are separated from each other can be suppressed.

In addition, according to the embodiment of the invention, by including the elastic element 53 which supports the presser roller 52, the space defined between the rotational portion 51 and the presser roller 52 can be changed flexibly so as to cope with band-shaped accessories having different thicknesses.

Additionally, according to the embodiment of the invention, due to the rotational portion 51 including the pressing portions 62, 64, by rotating the rotational portion 51, the band-shaped accessory which is inserted into the space defined between the rotational portion 51 and the presser roller 52 can be moved in an ensured fashion with no slippage involved.

Further, according to the embodiment of the invention, by adopting the katyusha 100 as the band-shaped accessory, patterns on the katyusha 100 can be changed variously, whereby the user can enjoy a variety of dressing up situations.

In addition, according to the embodiment of the invention, by rotating the rotational portion 51 manually or electrically using the electric motor, the decorative tape 22 can easily be affixed to the band-shaped accessory.

Additionally, the invention is not limited to the embodiment but can be modified or improved freely without departing from the spirit and scope thereof.

What is claimed is:

1. A tape affixing apparatus for a band-shaped accessory for affixing a decorative tape to a band-shaped accessory which is curved substantially into an arc-like shape and which has flexibility, comprising a main body, wherein
the main body has:
an insertion port from which the band-shaped accessory can be inserted;
a rotational portion which moves the band-shaped accessory inserted in a predetermined direction; and
a presser roller which presses the band-shaped accessory inserted vertically together with the rotational portion, and wherein
the decorative tape is affixed to a surface of the band-shaped accessory by inserting the band-shaped accessory into the insertion port in the main body and rotating the rotational portion.

2. A tape affixing apparatus for a band-shaped accessory as set forth in claim 1, further comprising a tape holding device which is adapted to accommodate the decorative tape therein and which can be incorporated in the main body, wherein
the tape holding device which accommodates the decorative tape is connected to the main body.

3. A tape affixing apparatus for a band-shaped accessory as set forth in claim 1, wherein
the decorative tape is a decorative tape for a band-shaped accessory which is made up of the decorative tape and a strippable paper carrier.

4. A tape affixing apparatus for a band-shaped accessory as set forth in claim 2, wherein
the decorative tape is a decorative tape for a band-shaped accessory which is made up of the decorative tape and a strippable paper carrier.

5. A tape affixing apparatus for a band-shaped accessory as set forth in claim 2, wherein
the decorative tape is a decorative tape which is made up of the decorative tape and a strippable paper carrier, and wherein the tape holding device has:
a guide plate which guides the decorative tape of the decorative tape;
a separation guide which separates the decorative tape from the strippable paper carrier of the decorative tape; and
a discharge port from which the strippable paper carrier of the decorative tape which is separated from the decorative tape is discharged.

6. A tape affixing apparatus for a band-shaped accessory as set forth in claim 5, wherein
the tape holding device comprises a winding shaft which winds up the decorative tape to lock it therearound.

7. A tape affixing apparatus for a band-shaped accessory as set forth in claim 6, wherein
the tape holding device comprises projecting portions where the decorative tape and the strippable paper carrier of the decorative tape which is wound around the winding shaft to be locked therearound are temporarily fastened when the decorative tape and the strippable paper carrier are separated from each other.

8. A tape affixing apparatus for a band-shaped accessory as set forth in claim 1, wherein
the main body comprises an elastic element which supports the presser roller.

9. A tape affixing apparatus for a band-shaped accessory as set forth in claim 2, wherein
the main body comprises an elastic element which supports the presser roller.

10. A tape affixing apparatus for a band-shaped accessory as set forth in claim 3, wherein
the main body comprises an elastic element which supports the presser roller.

11. A tape affixing apparatus for a band-shaped accessory as set forth in claim 4, wherein
the main body comprises an elastic element which supports the presser roller.

12. A tape affixing apparatus for a band-shaped accessory as set forth in claim 5, wherein
the main body comprises an elastic element which supports the presser roller.

13. A tape affixing apparatus for a band-shaped accessory as set forth in claim 6, wherein
the main body comprises an elastic element which supports the presser roller.

14. A tape affixing apparatus for a band-shaped accessory as set forth in claim 7, wherein
the main body comprises an elastic element which supports the presser roller.

15. A tape affixing apparatus for a band-shaped accessory as set forth in claim 1, wherein
the rotational portion comprises a pressing portion having elasticity.

16. A tape affixing apparatus for a band-shaped accessory as set forth in claim 2, wherein
the rotational portion comprises a pressing portion having elasticity.

17. A tape affixing apparatus for a band-shaped accessory as set forth in claim 3, wherein
the rotational portion comprises a pressing portion having elasticity.

18. A tape affixing apparatus for a band-shaped accessory as set forth in claim 4, wherein
the rotational portion comprises a pressing portion having elasticity.

19. A tape affixing apparatus for a band-shaped accessory as set forth in claim 5, wherein
the rotational portion comprises a pressing portion having elasticity.

20. A tape affixing apparatus for a band-shaped accessory as set forth in claim 6, wherein
the rotational portion comprises a pressing portion having elasticity.

21. A tape affixing apparatus for a band-shaped accessory as set forth in claim 7, wherein
the rotational portion comprises a pressing portion having elasticity.

22. A tape affixing apparatus for a band-shaped accessory as set forth in claim 8, wherein
the rotational portion comprises a pressing portion having elasticity.

23. A tape affixing apparatus for a band-shaped accessory as set forth in claim 1, wherein
the band-shaped accessory is a katyusha.

24. A tape affixing apparatus for a band-shaped accessory as set forth in claim 1, wherein
the rotational portion is rotated manually or electrically using an electric motor.
